(19) United States
(12) Patent Application Publication
(10) Pub. No.: US 2023/0048921 A1
(43) Pub. Date: Feb. 16, 2023

(54) SILICON-POLYMER BASED COMPOSITE ANODES FOR LITHIUM-ION BATTERIES AND METHODS OF MAKING THE SAME

(71) Applicant: NOHMS Technologies, Inc., Rochester, NY (US)

(72) Inventors: Surya S. Moganty, Henrietta, NY (US); Rutvik Vaidya, Rochester, NY (US); Xiaojing Zhu, Rochester, NY (US)

(21) Appl. No.: 17/884,815

(22) Filed: Aug. 10, 2022

Related U.S. Application Data
(60) Provisional application No. 63/232,330, filed on Aug. 12, 2021.

(51) Int. Cl. C08J 3/20; C08K 3/34; H01M 4/04; H01M 4/38; H01M 4/60; H01M 4/66; H01M 10/0525; H01M 10/0568; H01M 10/0569

(52) U.S. Cl. CPC C08J 3/20; C08K 3/34; H01M 4/0404; H01M 4/386; H01M 4/604; H01M 4/661; H01M 10/0525; H01M 10/0568; H01M 10/0569; C08J 2333/20; H01M 2004/021

(57) ABSTRACT

A silicon-polymer composite anode having two or more different molecular weight (MW) versions of the same polymer, method of making the anode and electrochemical energy storage device containing the anode are disclosed.

This application claims the benefit of the filing date of U.S. Provisional Patent Application No. 63/232,330, filed Aug. 12, 2021, which is hereby incorporated by reference in its entirety.

### FIELD

The present disclosure relates to silicon-polymer composite anodes for use in, e.g., lithium-ion batteries. More specifically, the present disclosure relates to silicon-polymer anodes having two or more different molecular weight (MW) versions of the same polymer and methods of making silicon-polymer anodes using two or more different MW versions of the same polymer.

### BACKGROUND

Lithium ion (Li-ion) batteries are heavily used in consumer electronics, electric vehicles (EVs), energy storage systems (ESS) and smart grids. The energy density of Li-ion batteries is dependent at least in part on the anode and cathode materials used. Optimizing processing and manufacturing of Li-ion batteries has allowed for a 4-5% improvement in the energy density of Li-ion batteries each year, but these incremental improvements are not sufficient for reaching energy density targets of next-generation technologies. In order to reach such targets, advancements in electrode materials will be required, such as incorporating high energy-density active materials into electrodes. Recent research has focused primarily on developing high energy cathodes, with only limited research dedicated to the development of anode materials.

Recently, silicon (Si) has emerged as one of the most attractive high energy anode materials for Li-ion batteries. Silicon's low working voltage and high theoretical specific capacity of 3579 mAh/g is nearly ten times that of conventional graphite, thus resulting in increased interest. Yet despite this significant advantage, anodes composed of silicon particles face several challenges associated with severe volume expansion and the resultant particle breakdown. While graphite-based electrodes expand 10-15% during lithium intercalation, Si-based electrodes expand ˜300%, causing structural degradation and instability of the solid-electrolyte-interphase (SEI) layer. This causes material pulverization and electrode delamination, resulting in loss of capacity with cycling.

One approach to addressing this problem is the use of specific binder materials in Si-based anodes for protecting the Si particles and providing the overall Si-based anode with elasticity and mechanical robustness. In one approach, the silicon particles are coated with a polymer binder such as polyacrylonitrile (PAN), followed by controlled heat treatment of the PAN-coated silicon particles to cyclize the PAN. However, this approach depends on the ability to preferentially coat silicon particles with PAN during manufacturing. Accordingly, a need exists for improved methods of preparing Si-based anodes wherein the polymer binder suitably and sufficiently coats the Si particles.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Described herein are various embodiments of silicon-polymer anodes and methods of making the same, including methods of ensuring that silicon particle components of the silicon-polymer anodes are suitably and sufficiently coated with a binder material.

In some embodiments, the method of making the silicon-polymer anode generally includes the steps of mixing together silicon particles, a low molecular weight polymer, and a high molecular weight polymer to form a mixture, coating the mixture onto a copper current collector to form a coated copper current collector; and subjecting the coated copper current collector to a temperature treatment. In some embodiments, the polymer is polyacrylonitrile (PAN). In some embodiments, the low molecular weight PAN has a molecular weight in the range of from about 1,000 to about 85,000, and the high molecular weight PAN has a molecular weight in the range of from about 90,000 to about 5,000,000.

In some embodiments, an electrochemical energy storage device generally includes an anode, a cathode, and an electrolyte. The anode may include a plurality of active material particles and at least one polymer, wherein at least two different molecular weight versions of the polymer are incorporated into the anode. The plurality of active material may be silicon particles having a particle size of between about 1 nm and about 100 μm. The two different molecular weight versions of the polymer may be a low molecular weight version having a molecular weight in the range of from about 1,000 to about 85,000 and a high molecular weight version having a molecular weight in the range of from about 90,000 to about 5,000,000. In some embodiments, the polymer is polyacrylonitrile (PAN), such that the anode includes low molecular weight PAN and high molecular weight PAN.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a flow diagram illustrating a method of making silicon-polymer composite anodes according to various embodiments of the technology described herein;

FIG. 2 is a schematic illustration of a silicon-polymer composite anode according to various embodiments of the technology described herein;

FIG. 3 is a graph of DSC data for PAN polymers with molecular weights from 80K to 200K; and

FIG. 4 shows FT-IR profiles for comparative heat-treated anodes and a heat-treated anode prepared according to an embodiment of the technology described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Described herein are various embodiments of a silicon-polymer anode composite material, methods of making the same, and an energy storage device incorporating the silicon-polymer anode material.

Any suitable Si-composite material can be used for the Si particles included in the anode material described herein. In some embodiments, the Si-composite particles are Si-carbon composite materials, such as carbon coated Si particles. In some embodiments, silicon oxides (SiOx) are used. The Si-composite can also be an alloy of Si with inert metals or non-metals. Other examples of Si-composite materials suitable for use in the embodiments described herein are graphene-silicon composites, graphene oxide-silicon-carbon nanotubes, silicon-polypyrroles, and composites of nano and micron sized silicon particles. As described previously, any combination of Si-composite materials can be used in the anode material, or just a single Si-composite material can be used.

The polymer used in the anode is provided in at least two different molecular weight versions of the same polymer—a low molecular weight version of the polymer and a high molecular weight version of the polymer. The chain length of the polymer determines the molecular weight of the polymer, and thus the low molecular weight form has a shorter chain length than the high molecular weight form. Because the chain length impacts the melting point of the polymer, the low molecular weight polymer will have a lower melting point than the higher molecular weight polymer. Upon heat treatment of the polymer, the lower molecular weight polymer melts first and selectively encapsulate the silicon active materials. As a result, the lower molecular weight polymer forms a protective layer around the active material particles in a controlled manner. The higher molecular weight polymer then melts and provides a more macro level protection for the anode as a whole. The resulting silicon-polymer anode composite material reduces volume expansion and the resultant particle breakdown of the anode.

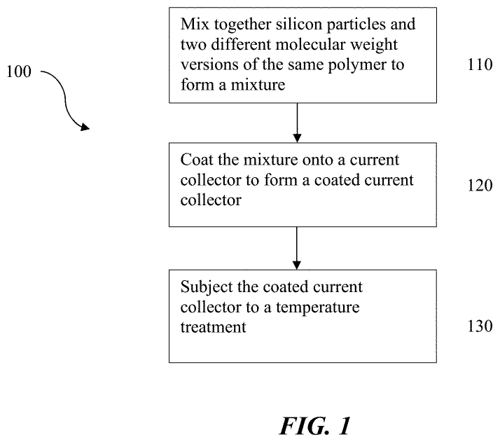

With reference to FIG. 1, a flow diagram showing an embodiment of a method 100 for preparing the composite anode material described herein generally includes step 110 of mixing together silicon particles and a polymer binder to form a mixture, wherein the polymer binder includes at least two different molecular weight versions of the polymer binder, a step 120 of adding a solvent to the mixture and coating the mixture on a current collector, and a step 130 of removing the solvent from the coating and subjecting the coated current collector to a heat treatment.

With respect to step 110, silicon particles and at least on polymer binder are mixed together to form a mixture, wherein the at least one polymer binder is provided in the form of at least a high molecular weight version of the polymer and at least a low molecular weight version of the polymer. Any manner of mixing together these materials can be used. In some embodiments, mechanical mixing is used. For example, the components can be mixed together by ball milling the solids at low rpm.

In some embodiments, the polymer binder material is polyacrylonitrile (PAN). The low molecular weight version of the PAN can have a MW in the range of from about 1,000 to about 85,000. The high molecular weight version of the PAN can have a MW in the range of from about 90,000 to about 5,000,000. PAN is a polymer with the chemical formula (C₃H₃N)ₙ. PAN as used herein also includes copolymers of PAN as almost all PAN produced for commercial applications are copolymers obtained from mixing acrylonitrile with other monomers. For example, with vinyl esters (vinyl acetate, methyl acrylate and methyl methacrylate) in textile applications; with acrylamide, vinylpyrrolidone and itaconic acid in carbon fiber applications; with vinyl chloride and vinylidene chloride in anti-flame modacrylic fibers; styrene is used in SAN thermoplastic resin and in ABS.

In some embodiments, the mixture includes from about 30 wt. % to about 90 wt. % silicon particles, and from about 10 wt. % to about 40 wt. % polymer (combined high and low molecular weight versions). In some embodiments, the ratio of low to high molecular weight polymer in the polymer component of the mixture is in the range of from about 1:1 to about 1:10, such as in the range of from about 1:3 to about 1:5.

In step 120, a solvent is added to the mixture to disperse the active materials. Any suitable solvent can be used at any suitable amount. In some embodiments, the solvent is anhydrous NMP. Other suitable solvents include, but are not limited to, N,N-dimethylformamide (DMF), dimethyl sulfone (DMSO₂), dimethyl sulfoxide (DMSO), ethylene carbonate (EC), and propylene carbonate (PC). The solvent can be mixed with the mixture of silicon and polymer for any suitable amount of time, such as around 12 hours. For example, shear and centrifugal mixing can be used to disperse the solids in the solvent.

Step 120 further includes coating the slurry mixture on a current collector. The material of the current collector can be any suitable current collector material, such as copper. Any suitable manner for coating the mixture on the current collector can be used. In some embodiments, the coating step can be carried out using a benchtop doctor-blade coater or the like.

In step 130, the solvent is removed from the material coated on the current collector and the coated current collector is subjected to a heat treatment. While this step can be described as two separate actions, it may be possible in some embodiments to remove the solvent from the coating as part of the heat treatment step. When solvent is removed first, the solvent can be removed by heating the coating at a temperature generally below the temperature used in the subsequent heat treatment step. For example, in some embodiments, the solvent is removed from the coating by first subjecting the coated current collector to a temperature of about 60° C. (such as in a convection oven) to evaporate off the solvent.

Following solvent removal, step 130 continues with the coated current collector being subjected to a heat treatment. The heat treatment may include heating the coated current collector in an inert atmosphere to a temperature in the range of from about 150° C. to about 600° C., such as in an inert argon gas atmosphere at about 330° C. The heat treatment step is generally aimed at cyclizing the polymer component of the coating. As described previously, in some embodiments, the polymer component of the coating is PAN. Cyclization of PAN is the process when the nitrile bond (C≡N) gets converted to a double bond (C═N) due to crosslinking of PAN molecules. This process yields ladder polymer chains of PAN fiber that are elastic but mechanically robust, thus allowing for controlled fragmentation of silicon particles.

Studies have shown that during the carbonization treatment process, the ring structures of PAN pre-oxidized fiber are transformed into pseudo-graphite structure of carbon fiber. Generally, the carbonization process includes two stages, low-temperature carbonization at 300° C. to about 700° C. and high-temperature carbonization at 700° C. to about 1500° C. During the carbonization process, the ring structure of PAN pre-oxidized fiber underwent the complex pyrolysis and reconstruction, in which the original chemical and physical structures were destroyed. Meanwhile, the smaller cyclized structural units were gradually transformed to the pseudo-graphite structure through the crosslinking, polycondensation and pyrolysis accompanied shrinking significantly. As a result, the original structure of stabilized fiber completely disappeared and a new pseudo-graphite microcrystalline structure was generated. Through the pyrolysis, polycondensation and reconstruction, the cyclized structure and its aggregation structure of PAN-based pre-oxized fiber in the process of low-temperature carbonization were significantly changed. At the first stage, when the heat-treated temperature was lower than 450° C., the mainly chemical reactions were the dehydrogenation and pyrolysis in acyclic linear molecular chain or partial cyclized structure. At this stage, the growth of cyclized structure was not obvious, However, a large number of pyrolysis affected the destruction of the original pre-oxidized structure. It led to significant increase of internal stress and further induced the reorientation of the cyclized structure. At the second stage, when the heat-treated was higher than 450° C., the degree of dehydrogenation and pyrolysis decreased rapidly and the polycondensation and reconstruction of aromatic heterocyclic structure was gradually in domain. The early reconstruction process of aromatic heterocycles was random and unevenly distributed. A series of heterocycles structures with different scales was formed with defects and was further aligned under the induction of tension. At this stage, the new pseudo-graphite crystalline structure gradually formed, and the d-spacing of graphite layer decreased slightly and crystallites size increased slowly with the increase of heat-treated temperature. At the third stage, after the heat-treatment at 550° C., the pseudo-graphite base structure formed gradually. With the increase of heat-treated temperature, the d-spacing were further reduced slightly, and the crystallites size increased slowly. A new ordered structure similar to final structure of carbon fiber was gradually developed.

As noted previously, the low MW version of PAN and the high MW version of PAN have different melting temperatures. For example, the low MW version of PAN may have a melting temperature of from about 150° C. to about 400° C., while the high MW version of PAN may have a melting temperature of from about 250° C. to about 600° C. In order to take advantage of the low molecular weight PAN selectively encapsulating the silicon particles, the heat treatment portion of step 130 may be carried out via a gradual or stepwise increase in temperature. In a gradual heating process, the temperature is continuously raised. When the melting temperature of the low MW PAN is met, the low MW PAN selectively coats the silicon particles, while the high MW PAN remains unimpacted until the gradually increasing temperature hits the melting temperature of the high MW PAN. At that point, the high MW PAN forms a macro level protection for the composite anode as a whole. In a step wise approach, the temperature is set at the low MW PAN melting temperature and held there for a time period sufficient to result in selective coating of the silicon particles with the low MW PAN, after which the temperature is raised to and held at the melting temperature of the high MW PAN for creation of the macro level anode protection.

The anode composite material prepared via the methods described herein generally includes at least two materials: silicon and polymer. As previously described, the silicon is typically provided in the form of particles and the polymer is provided in at least two different MW versions of the polymer. As described in greater detail below, the anode material may include additional materials, but the silicon and polymer are the primary ingredients of the anode composite material.

In some embodiments, the silicon is present in the anode composite material in the form of silicon particles. The size of the silicon particles can be in the range of from about 1 nm to about 100 μm. In some embodiments, the silicon particles are from about 30 wt. % to about 90 wt. % of the anode composite material, such as from about 50 wt. % to about 80 wt. %.

The anode composite material further includes at least one polymer. The polymer component of the anode composite material typically serves as a binder material. In some embodiments, the at least one polymer is polyacrylonitrile (PAN). Other polymer materials may also be included in the anode composite material as needed. In some embodiments, the polymer is from about 10 wt. % to about 40 wt. % of the anode composite material. As noted previously, PAN is used as a polymer binder to form elastic but robust films to allow for controlled fragmentation/pulverization of silicon particles within the binder matrix.

The PAN polymer is provided in the anode in at least two different MW versions. For example, the anode composite may include a low MW version of PAN and a high molecular weight version of PAN. The low molecular weight version of the PAN can have a MW in the range of from about 1,000 to about 85,000. The high molecular weight version of the PAN can have a MW in the range of from about 90,000 to about 5,000,000.

While the present disclosure primarily describes embodiments where the anode composite includes two different MW versions of the polymer binder material, it should be appreciated that the anode composite material could also include three, four, five or more different MW versions of the polymer, such as PAN.

Other materials that may be present in the anode composite material include, but are not limited to, hard-carbon, graphite, tin, and germanium particles. When present in the anode composite material, these materials may be present in a range of from about 0.1 wt. % to about 50 wt. % of the anode composite material.

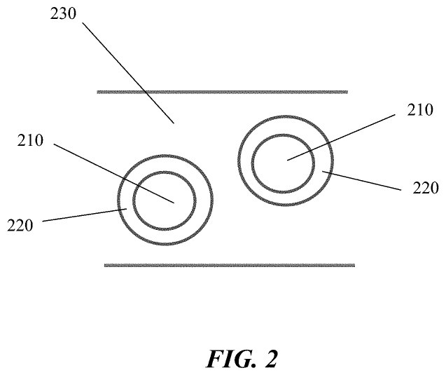

With reference to FIG. 2, the materials of the anode composite material may be arranged in a specific orientation. In some embodiments, the low MW PAN 220 surrounds, sandwiches, encapsulates or otherwise coats the silicon particles 210. As shown in FIG. 2, the low MW PAN 220 surrounds one silicon particle. However, it should be appreciated that multiple silicon particles 210 could be encapsulated together by low MW PAN 220. As also shown in FIG. 2, the combination of silicon particles 210 encapsulated by low MW PAN 220 are encapsulated or bound together by the high MW PAN 230. In this configuration, a plurality of low MW PAN-encapsulated silicon particles is dispersed throughout the high MW PAN polymer binder matrix to form the specific orientation of the anode composite material described herein. It should be appreciated that while FIG. 2 shows the low MW PAN and high MW PAN as being distinct and distinguishable components for illustrative purposes, the low MW PAN and high MW PAN may actually be indistinguishable in the final anode composite material.

The low MW PAN 220 surrounding the silicon particles 210 may further include additional materials, such as the hard-carbon, graphite, tin, and germanium particles mentioned previously. Thus, in some embodiments, the silicon particles 210 are surrounded by a layer of low MW PAN mixed with one or more of hard-carbon, graphite, tin, and germanium particles.

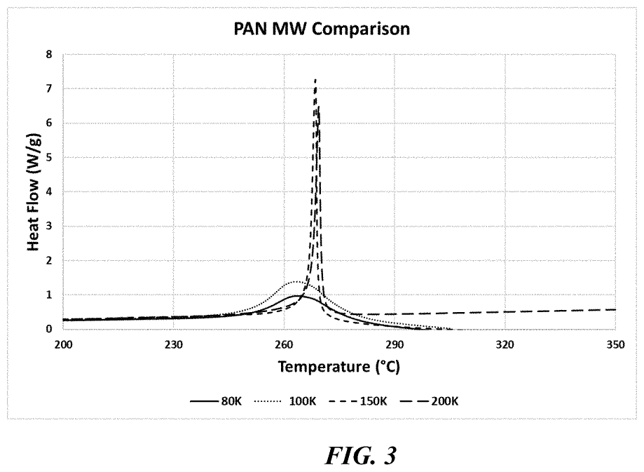

FIG. 3 shows the DSC data in the temperature range of 25 to 500° C. at 1.7° C./min, PAN polymers with molecular weights (MWs) from 80K to 200K. Peak temperatures of PAN with 4200 MW and 15200 MW are around 235 to 240° C., whereas higher molecular weights of PAN have peak temperatures around 260 to 270° C. Both 80K and 100K MW PAN has broad exothermic peaks around 263° C., whereas the higher molecular weight versions (150K and 200K) of PAN show sharper peaks around 265 to 270° C. The broader peaks in the 80K and 100K MW PAN profiles are indicated by higher enthalpy and can be a result of complete conversion of 5-6 nitrile (C≡N) to C═N. This data is shown in Table 1 below.

TABLE 1
DSC data Comparison

| PAN MW | Peak Temp. (° C.) | Enthalpy (J/g) |
|---|---|---|
| 4200 | 240.8 | n/a |
| 15200 | 236.2 | n/a |
| 80000 | 263.7 | 779.0 |
| 100000 | 262.6 | 675.2 |
| 150000 | 268.5 | 576.5 |
| 200000 | 264.9 | 585.5 |

The anode composite material described herein can be incorporated into an electrochemical energy storage device. The electrochemical energy storage device generally includes the anode material as described herein, a cathode, and an electrolyte. In some embodiments, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery.

Suitable cathodes for use in the electrochemical energy storage device include those such as, but not limited to, a lithium metal oxide, spinel, olivine, carbon-coated olivine, LiCoO₂, LiNiO₂, LiMn_{0.5}Ni_{0.5}O₂, LiMn_{0.3}Co_{0.3}Ni_{0.3}O₂, LiMn₂O₄, LiFeO₂, LiNiₓCo_{y}Met_{z}O₂, A_{n′}B₂(XO₄)₃, vanadium oxide, lithium peroxide, sulfur, polysulfide, a lithium carbon monofluoride (also known as LiCFₓ) or mixtures of any two or more thereof, where Met is Al, Mg, Ti, B, Ga, Si, Mn or Co; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, and 0≤z≤0.5 and 0≤n¹≤0.3. According to some embodiments, the spinel is a spinel manganese oxide with the formula of Li₁₊ₓMn_{2-z}Met′″_{y}O₄₋ₘX′ₙ, wherein Met′″ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of LiFePO₄, or Li₁₊ₓFe_{1z}Met″_{y}PO₄₋ₘX′ₙ, wherein Met″ is Al, Mg, Ti, B, Ga, Si, Ni, Mn or Co; X′ is S or F; and wherein 0≤x≤0.3, 0 0≤y≤0.5, 0≤z≤0.5, 0≤m≤0.5 and 0≤n≤0.5.

In some embodiments, the electrolyte component of the electrochemical energy storage device includes a) an aprotic organic solvent system; and b) a metal salt. In an embodiment, the aprotic organic solvent system is in a range of from 60% to 90% by weight of the electrolyte. In an embodiment, the metal salt is in a range of 10% to 30% by weight of the electrolyte.

In some embodiments, the electrolyte includes an aprotic organic solvent system selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof in a range of from 60% to 90% by weight.

In some embodiments, the electrolyte includes a lithium salt in a range of from 10% to 30% by weight. A variety of lithium salts may be used, including, for example, Li(AsF₆); Li(PF₆); Li(CF₃CO₂); Li(C₂F₅CO₂); Li(CF₃SO₃); [N(CP₃SO₂)₂]; [C(CF₃SO₂)₃]; [N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)₂]; Li[BF₂C₂O₄]; Li₂[B₁₂Z₁₂₋ⱼHⱼ]; Li₂[B₁₀X_{10-j′}H_{j′}]; or a mixture of any two or more thereof, wherein Z is independent at each occurrence a halogen, j is an integer from 0 to 12 and j′ is an integer from 1 to 10.

In some embodiments the electrolyte contains an additive, such as a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof. In some embodiments, the additive is an ionic liquid. Further, the additive is present in a range of from 0.01% to 10% by weight of the electrolyte.

In some embodiments where the electrochemical energy storage device is a secondary battery, the secondary battery may further include a separator separating the positive and negative electrode. The separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

The disclosure will be further illustrated with reference to the following specific examples. It is understood that these examples are given by way of illustration and are not meant to limit the disclosure or the claims to follow.

### EXAMPLE 1

### Preparation of Silicon-Polymer Anodes with Different PAN MWs

1 μm silicon powder was mixed with 80,000 MW (80K PAN) and 200,000 MW (200K PAN) PAN by ball milling the solids at low rpm, and the ratio of silicon:80K PAN: 200K PAN was 8:1:1. Anhydrous DMF was used as solvent to disperse the conductive carbon additive C65 using centrifugal mixing before adding the silicon PAN solid mixture to the dispersion. The slurry was mixed overnight, and a benchtop doctor-blade coater was used to slurry the slurry on to copper current collectors to get electrodes with >3 mg/cm² solid loadings. The electrodes were then dried at 60° C. in a convection oven before heat treatment in an inert argon atmosphere at 330° C.

### EXAMPLE 2

### Preparation of Comparative Silicon-Polymer Anodes

Comparative electrodes were made with 1 μm silicon powder mixed with 80K PAN with the ratio of silicon:80K PAN 8:2 (Comparative Example 2A) and with 200K PAN where the ratio of silicon:200K PAN was 8:2 (Comparative Example 2B). Similar mixing and coating procedure was used to generate electrodes with >3 mg/cm² solid loadings before drying them at 60° C. in a convection oven. The comparative electrodes were then heat treated in an inert argon atmosphere at 330° C.

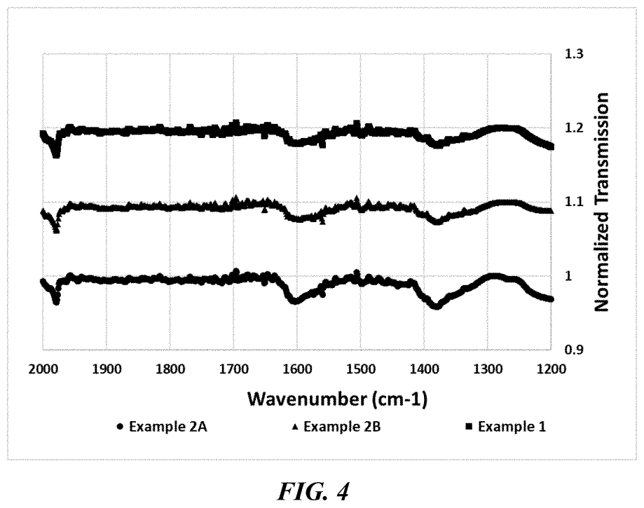

FT-IR profiles in FIG. 4 for a comparison of the heat-treated anodes show indication of PAN cyclization based on the sharp peak at 1600 cm⁻¹ corresponding to C═N.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method of making anode active material comprising silicon and at least one polymer material for an electrochemical energy storage device, the method comprising:
a) mixing together silicon particles and at least two different molecular weight versions of a polymer to form a mixture;
b) coating the mixture onto a current collector to form a coated current collector; and
c) subjecting the coated current collector to a temperature treatment.

2. The method of claim 1, wherein the polymer is polyacrylonitrile.

3. The method of claim 1, wherein the at least two different molecular weight versions of the polymer comprise a low molecular weight version having a molecular weight in the range of from 1,000 to 85,000 and a high molecular weight version of the polymer having a molecular weight in the range of from 90,000 to 5,000,000.

4. The method of claim 3, wherein the ratio of low molecular weight version to high molecular weight version of the polymer is from 1:1 to 1:10.

5. The method of claim 4, wherein the ratio of low molecular weight version to high molecular weight version of the polymer is from 1:3 to 1:5.

6. The method of claim 1, wherein the mixture comprises from about 30 wt. % to about 90 wt. % of the silicon particles and from about 10 wt. % to about 40 wt. % of the polymer.

7. The method of claim 3, wherein subjecting the coated current collector to the temperature treatment comprises heating the coated current collector in an inert atmosphere to a temperature in the range of from about 150° C. to about 600° C.

8. The method of claim 7, wherein heating the coated current collector comprises heating the coated current collector at a first temperature sufficient to melt the low molecular weight version of the polymer and then heating the coated current collector at a second temperature sufficient to melt the high molecular weight version of the polymer.

9. The method of claim 1, further comprising:
after step a) and before step b), adding a solvent to the mixture to disperse the silicon particles and the at least two different molecular weight versions of the polymer, the solvent being selected from the group consisting of N-methyl-2-pyrrolidone (NMP), N,N-dimethylformamide (DMF), dimethyl sulfone (DMSO₂), dimethyl sulfoxide (DMSO), ethylene carbonate (EC), and propylene carbonate (PC).

10. The method of claim 9, further comprising:
after step b) and prior to step c), removing the solvent from the mixture coated on the copper current collector.

11. The method of claim 9, wherein step c) removes the solvent from the mixture coated on the copper current collector.

12. The method of claim 1, wherein the size of the silicon particles ranges from about 1 nm to about 100 μm.

13. An electrochemical energy storage device comprising:
an anode comprising:
a plurality of active material particles, wherein each of the plurality of active material particles has a particle size of between about 1 nm and about 100 μm, and a low molecular weight version and a high molecular weight version of a polymer, wherein the plurality of active material particles are enclosed by the low molecular weight version of the polymer;
a cathode; and
an electrolyte including at least one lithium salt.

14. The electrochemical energy storage device of claim 13, wherein the plurality of active material particles are silicon particles.

15. The electrochemical energy storage device of claim 13, wherein the low molecular weight version of the polymer encapsulates one or more of the active material particles to form low molecular weight polymer-encapsulated active material particles which are further enclosed by the high molecular weight version of the polymer.

16. The electrochemical energy storage device of claim 13, wherein the polymer comprises polyacrylonitrile.

17. The electrochemical energy storage device of claim 13, wherein the cathode comprises a lithium metal oxide, spinel, olivine, carbon-coated olivine, vanadium oxide, lithium peroxide, sulfur, polysulfide, a lithium carbon monofluoride or mixture thereof.

18. The electrochemical energy storage device of claim 13, wherein the cathode is a transition metal oxide material and comprises an over-lithiated oxide material.

19. The electrochemical energy storage device of claim 13, wherein the electrolyte includes a) an aprotic organic solvent system; and b) a metal salt, wherein the metal salt includes a lithium salt.

20. The electrochemical energy storage device of claim 13, further comprising:
a porous separator separating the anode and the cathode from each other.

21. A silicon-polymer composite electrode comprising:
a plurality of active material particles, wherein each of the plurality of active material particles has a particle size of between about 1 nm and about 100 μm; and
a low molecular weight version and a high molecular weight version of a polymer, wherein the plurality of active material particles is enclosed by the low molecular weight version of the polymer and the enclosed plurality of active material particles is further enclosed by the high molecular weight version of the polymer.

22. The electrode of claim 21, wherein the polymer is polyacrylonitrile.

23. The electrode of claim 21, wherein the low molecular weight version of the polymer has a molecular weight in the range of from 1,000 to 85,000 and the high molecular weight version of the polymer has a molecular weight in the range of from 90,000 to 5,000,000.

24. The electrode of claim 21, wherein the ratio of low molecular weight polymer to high molecular weight polymer is from 1:1 to 1:10.

25. The electrode of claim 24, wherein the ratio of low molecular weight polymer to high molecular weight polymer is from 1:3 to 1:5.

26. The electrode of claim 21, wherein the anode comprises from about 30 wt. % to about 90 wt. % silicon active material particles and from about 10 wt. % to about 40 wt. % of the polymer.
